(19) United States
(12) Patent Application Publication
(10) Pub. No.: US 2013/0076811 A1
(43) Pub. Date: Mar. 28, 2013

(54) INKJET RECORDING APPARATUS

(71) Applicants: Yoshiyuki Honda, Kawasaki-shi (JP); Takeshi Murase, Yokohama-shi (JP); Atsushi Sakamoto, Yokohama-shi (JP); Minoru Teshigawara, Saitama-shi (JP); Makoto Torigoe, Tokyo (JP); Shigeyasu Nagoshi, Yokohama-shi (JP); Yoshiaki Murayama, Tokyo (JP); Susumu Hirosawa, Tokyo (JP); Yutaka Kano, Yokohama-shi (JP); Satoshi Azuma, Kawasaki-shi (JP); Kentarou Muro, Tokyo (JP); Kei Kosaka, Tokyo (JP)

(72) Inventors: Yoshiyuki Honda, Kawasaki-shi (JP); Takeshi Murase, Yokohama-shi (JP); Atsushi Sakamoto, Yokohama-shi (JP); Minoru Teshigawara, Saitama-shi (JP); Makoto Torigoe, Tokyo (JP); Shigeyasu Nagoshi, Yokohama-shi (JP); Yoshiaki Murayama, Tokyo (JP); Susumu Hirosawa, Tokyo (JP); Yutaka Kano, Yokohama-shi (JP); Satoshi Azuma, Kawasaki-shi (JP); Kentarou Muro, Tokyo (JP); Kei Kosaka, Tokyo (JP)

(73) Assignee: CANON KABUSHIKI KAISHA, Tokyo (JP)

(21) Appl. No.: 13/614,972

(22) Filed: Sep. 13, 2012

(30) Foreign Application Priority Data
Sep. 27, 2011 (JP) 2011-211119

(51) Int. Cl. B41J 29/38

(52) U.S. Cl. 347/6

(57) ABSTRACT

An inkjet recording apparatus includes a recording head configured to discharge ink, a first ink tank configured to store ink to be supplied to the recording head, a circulation path configured to circulate ink between the first ink tank and the recording head, a measurement unit configured to measure an ink temperature in the circulation path, a second ink tank configured to replenish ink to the circulation path, and a control unit configured to control replenishment of ink from the second ink tank to the circulation path based on the ink temperature measured by the measurement unit.

### BACKGROUND OF THE INVENTION

1. Field of the Invention

The present invention relates to an inkjet recording apparatus that records a character or an image on a recording medium by discharging ink droplets from a nozzle according to print data.

2. Description of the Related Art

Japanese Patent Application Laid-Open No. 10-175315 discusses that an ink temperature control unit is provided to control the temperature of ink supplied to a nozzle of a print head so as to maintain the temperature within a setting temperature range in a configuration for circulating the ink between an ink tank and the print head. Japanese Patent Application Laid-Open No. 10-175315 also discusses that a temperature sensor included in an ink pressure chamber detects the ink temperature, and a printing operation is enabled under the condition that the detected ink temperature is within the setting temperature range. Further, Japanese Patent Application Laid-Open No. 10-175315 discusses that the printing operation is disabled if the temperature detected by the temperature sensor is higher or lower than the setting temperature range.

FIG. 7 is a flowchart illustrating a sequence discussed in Japanese Patent Application Laid-Open No. 10-175315. In step S90, a temperature of the ink supplied to the print head is detected, and is then compared with a first setting temperature range. If an ink temperature Tbd is within the first setting temperature range (Tbl<Tbd<Tbh), then in step S91, the printing operation is enabled. In step S92, the processing shifts to supply driving for supplying the ink to the print head. If the ink temperature Tbd is not within the first setting temperature range (NO in step S90), then in step S93, the printing operation is disabled. In step S94, the processing shifts to circulation driving for circulating the ink between the ink tank and the print head.

In step S95, the temperature of the ink tank is detected and is compared with a second setting temperature range. If an ink temperature Ttd in the ink tank is within the second setting temperature range (Ttl<Ttd<Tth) (YES in step S95), then in step S96, a heater in the ink tank is switched off. If the ink temperature Ttd is not within the second setting temperature range (NO in step S95), then in step S97, the heater in the ink tank is switched on to heat the ink in the ink tank, thereby increasing the ink temperature in the ink tank. If the ink temperature Tbd supplied to the nozzle of the print head reaches the first setting temperature range (Tbl<Tbd<Tbh) (YES in step S90), the printing operation is enabled.

Japanese Patent Application Laid-Open No. 2011-56784 discusses, in a configuration with an ink circulation mechanism for circulating ink among a first tank, a second tank, and a recording head, a detachable ink bottle for accommodating ink to be supplied to the ink circulation mechanism. However, as discussed in Japanese Patent Application Laid-Open No. 2011-56784, the temperature of the ink accommodated in the ink bottle excessively differs from the temperature suitable for recording in the configuration replenishing the ink from the ink bottle to the ink circulation mechanism. For example, the ink bottle is stored in a warehouse, so that the ink temperature in the ink bottle is excessively high or is contrarily excessively low.

If the ink at the temperature that is excessively different from the temperature suitable for recording is replenished to the ink circulation mechanism at once, there is a problem that an ink temperature control unit cannot control the ink temperature so as to maintain the temperature suitable for recording and then the printing operation is disabled. The ink temperature control unit has an ink circulation path with a predetermined length in a tub that is set at a predetermined temperature. If the difference of the ink temperature before passing through the ink temperature control unit and the temperature in the tub is within a predetermined temperature, the ink passes through the ink circulation path in the tub, so that the temperature of the ink passing through the ink temperature control unit becomes the same temperature as that in the tub. However, if the ink temperature before passing through the ink temperature control unit is greatly different from the temperature in the tub, the ink cannot be adjusted to the temperature in the tub even by passing the ink through the ink temperature control unit.

Therefore, if the ink temperature after passing the ink through the ink temperature control unit is not suitable for recording, it is determined that the ink temperature Tbd detected by the temperature sensor is not within the first setting temperature range (Tbl<Tbd<Tbh), and the printing operation is disabled. FIG. 6 is a graph illustrating a change in ink temperature when the ink at the temperature that greatly differs from the temperature suitable for recording is replenished to the ink circulation mechanism from the ink bottle. Referring to FIG. 6, T1 and T2 correspond to Tbl and Tbh, respectively. If ink at a low temperature is supplied from the ink bottle, specifically, when the ink temperature supplied to the print head is T1 (Tbl) or low, the printing operation is disabled.

### SUMMARY OF THE INVENTION

The present invention is directed to an inkjet recording apparatus in which an image forming operation does not stop even if ink at a temperature that is not suitable for the image forming operation is replenished from an external of a circulation path.

According to an aspect of the present invention, an inkjet recording apparatus includes a recording head configured to discharge ink, a first ink tank configured to store the ink to be supplied to the recording head, a circulation path configured to circulate the ink between the first ink tank and the recording head, a measurement unit configured to measure an ink temperature in the circulation path, a second ink tank configured to replenish the ink to the circulation path, and a control unit configured to control replenishment of the ink from the second ink tank to the circulation path based on the ink temperature measured by the measurement unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a circulation system according to a first exemplary embodiment of the preset invention.

FIG. 2 is a graph illustrating two temperature ranges and an ink temperature in the circulation system when ink is replenished according to the first exemplary embodiment of the preset invention.

FIG. 3 is a flowchart illustrating a control sequence according to the first exemplary embodiment of the preset invention.

FIG. 4 is a flowchart illustrating a control sequence according to a second exemplary embodiment of the present invention.

FIG. 5 is a graph illustrating a change in ink temperature when ink is replenished to a sub-tank from a main tank according to the second exemplary embodiment of the preset invention.

FIG. 6 is a graph illustrating a change in temperature according to a conventional art.

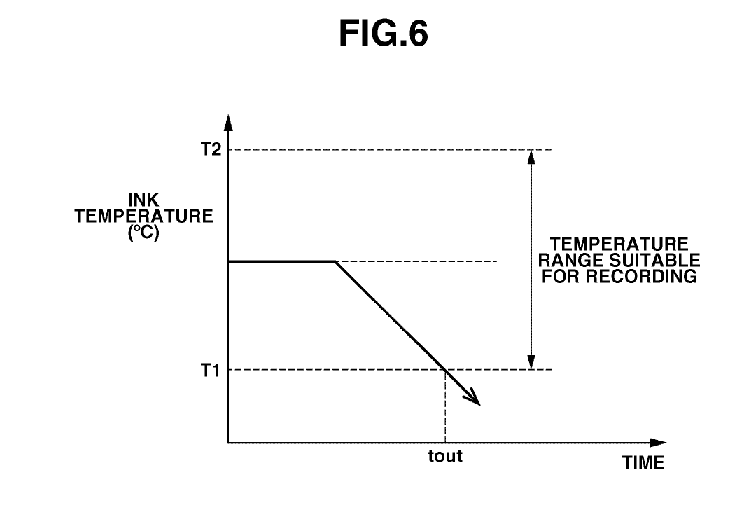

FIG. 7 is a flowchart illustrating a sequence according to the conventional art.

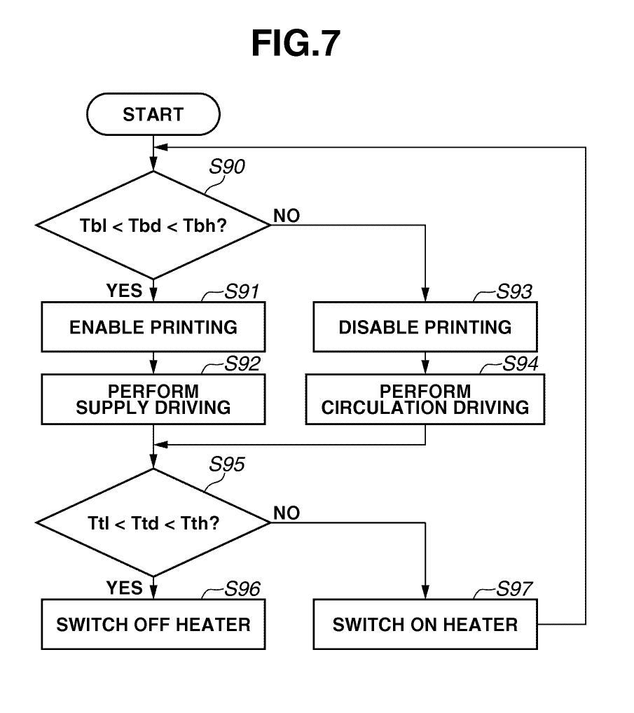

### DESCRIPTION OF THE EMBODIMENTS

Various exemplary embodiments, features, and aspects of the invention will be described in detail below with reference to the drawings.

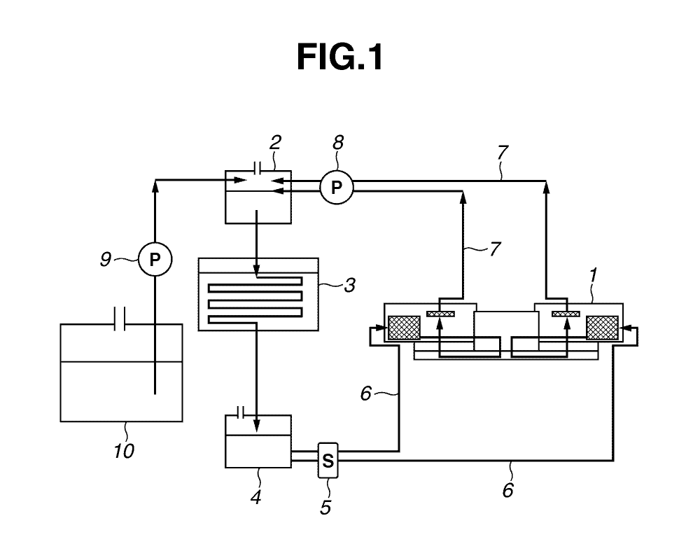

A configuration of an inkjet recording apparatus according to a first exemplary embodiment of the present invention with reference to FIG. 1 will be described. FIG. 1 illustrates a circulation system of the inkjet recording apparatus according to the present exemplary embodiment. The circulation system according to the present exemplary embodiment includes a recording head 1 as a line head and a sub-tank 2 (first ink tank) for storing ink to be supplied to the recording head 1. Further, the circulation system includes an ink temperature adjustment unit 3 configured to adjust the temperature of the ink supplied from the sub-tank 2 to the recording head 1. Furthermore, the circulation system includes a negative pressure source 4 for storing the ink passing through the ink temperature adjustment unit 3 to serve as a negative pressure source to the recording head 1. In addition, the circulation system includes an ink temperature measurement unit 5 configured to measure the temperature of the ink after passing though the ink temperature adjustment unit 3. According to the configuration of the present exemplary embodiment, the ink temperature measurement unit 5 is arranged on the downstream side of the negative pressure source 4. Alternatively, the ink temperature measurement unit 5 may be arranged at another position in a circulation path.

Further, the circulation system includes a supply path 6 that supplies the ink to the recording head 1 from the sub-tank 2, a collection path 7 that collects the ink which is not discharged by the line head to the sub-tank 2, and a circulation pump 8 that circulates the ink between the supply path 6 and the collection path 7.

According to the present exemplary embodiment, a main tank 10 (a second ink tank) replenishes the ink to the sub-tank 2 (a first ink tank) via a replenishment pump 9 for the circulation path. According to the present exemplary embodiment, a configuration for replenishing the ink from the main tank 10 to the sub-tank 2 is described. Alternatively, the ink may be replenished from the main tank 10 to another position in the circulation path.

With regard to the inkjet recording apparatus according to the present exemplary embodiment, the circulation path is provided for each ink color used for image formation excluding the ink temperature adjustment unit 3. Referring to FIG. 1, a configuration of only one ink color is illustrated.

The sub-tank 2 includes a liquid level sensor to measure the remaining ink amount. If the remaining ink amount in the sub-tank 2 is constant or less, the main tank 10 replenishes the ink to the sub-tank 2 to the set height of the liquid level. The main tank 10 is detachable to the inkjet recording apparatus. If the ink in the main tank 10 does not remain, another main tank 10 is detached/attached from/to the inkjet recording apparatus to replenish the ink.

Therefore, the sub-tank 2 can have the capacity for keeping the ink to continue the image formation during an exchange operation of the main tank 10 assuming that the main tank 10 is exchanged during the image forming operation. According to the present exemplary embodiment, the inkjet recording apparatus includes a sub-tank 2. However, a plurality of the sub-tanks 2 may be provided in the supply path 6 to the recording head 1 to reduce the ink pressure applied to the recording head 1 by the difference of potential head between the sub-tank 2 and the recording head 1, thereby distributing the pressure.

The ink temperature adjustment unit 3 configured to adjust the temperature of the ink supplied to the recording head 1 is arranged in the supply path 6. The ink temperature adjustment unit 3 is a temperature adjusting device including a tube for ink passage arranged with a predetermined distance in the tub fully containing water at an adjusted temperature. The ink in the circulation path passes through the ink temperature adjustment unit 3, thereby performing thermal exchange with the water in the tub to be adjusted to the set temperature. With reference to the configuration for the inkjet recording apparatus according to the present exemplary embodiment, an ink temperature adjustment unit 3 adjusts the temperature of the ink of ink circulation paths for all colors. The time for the ink passage through the tub in the ink temperature adjustment unit 3 is limited. Therefore, the ink temperature to be adjusted during the one-time ink passage in the tub is limited. According to the present exemplary embodiment, the temperature of the tub is set to 30° C. In order to adjust the ink temperature to 30° C. during the one-time passage through the ink temperature adjustment unit 3, the ink temperature before flowing into the ink temperature adjustment unit 3 needs to be 21° C. or more. That is, if the ink temperature before flowing into the ink temperature adjustment unit 3 is 20° C. or less, the temperature of the tub cannot be adjusted only during the one-time passage through the ink temperature adjustment unit 3.

With reference to the configuration according to the present exemplary embodiment, the ink temperature adjustment unit 3 adjusts the temperature of the ink circulation paths for all ink colors. Alternatively, the ink temperature adjustment unit 3 may be arranged with each ink circulation path.

With reference to the configuration according to the present exemplary embodiment, the ink temperature is adjusted with the water in the tub. Alternatively, the heater may be arranged in the circulation path or the circulation path may be heated by hot wind.

The ink temperature measurement unit 5 measures the ink temperature supplied to the recording head 1. The ink temperature measurement unit 5 is served to check whether the ink, the temperature of which is suitable for the image formation, is supplied to the recording head 1. Therefore, the ink temperature measurement unit 5 can be arranged on the downstream side of the ink temperature adjustment unit 3 and near the recording head 1. However, since the ink is circulated, the ink temperature measurement unit 5 may be disposed at any position in the circulation path. The ink temperature measurement unit 5 may directly measure the ink temperature, or may measure the temperature of a member forming the circulation path with high thermal conductivity.

A circulation pump 8 is driven to circulate the ink in the supply path 6 and the collection path 7.

According to the present exemplary embodiment, the circulation pump 8 is driven to obtain the circulation flux of the ink in the circulation path at a predetermined amount during the image forming operation. In a standby mode in which the image forming operation is not performed, driving speed of the circulation pump 8 may be slowed down.

A Control unit for each of the configurations is described to be performed based on information obtained by the ink temperature measurement unit 5. The control unit includes an ink temperature control unit, a determination unit for enabling the image forming operation, and a determination unit for enabling ink replenishment.

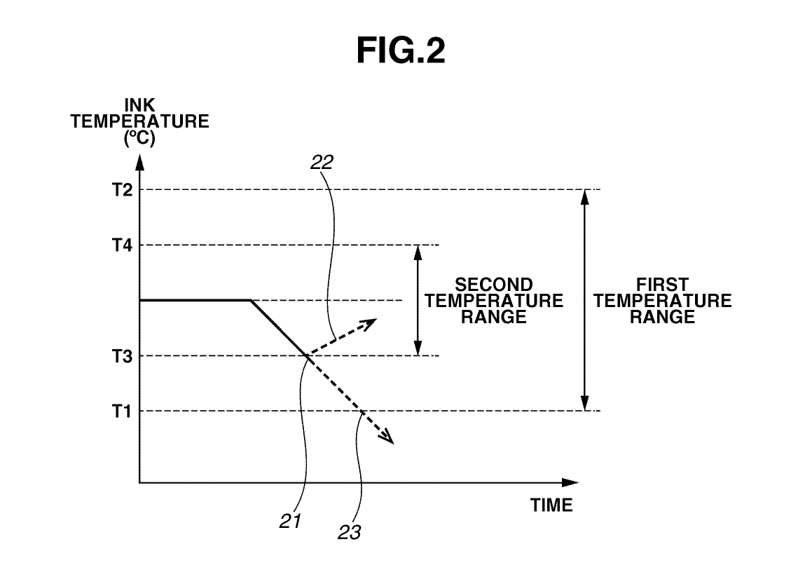

The ink temperature control unit includes in advance two temperature range tables (a first temperature range and a second temperature range) to compare the ink temperature measured by the ink temperature measurement unit 5 with the temperature range tables. FIG. 2 is a graph illustrating the two temperature ranges. The first temperature range (T1≦T (° C.)≦T2) ensures image forming quality in the image forming operation. The second temperature range (T3≦T(° C.)≦T4) is set within the first temperature range (T1<T3<T4<T2). The upper limit value and the lower limit value of each of the first and second temperature ranges may be varied depending on the ink colors, corresponding to a case where the temperature range for ensuring the image forming quality is different depending on physical properties of the ink such as the ink color.

If the ink temperature measured by the ink temperature measurement unit 5 is determined to be within the first temperature range, the determination unit for enabling the image forming operation enables the image forming operation. If the ink temperature is not determined to be within the first temperature range, the determination unit for enabling the image forming operation disables the image forming operation. If the ink temperature is within the second temperature range, the ink temperature is included in the first temperature range, and the determination unit for enabling the image forming operation therefore enables the image forming operation. If the ink temperature measured by the ink temperature measurement unit 5 is determined to be within the second temperature range, the determination unit for enabling the ink replenishment enables the ink replenishment operation from the main tank 10 to the sub-tank 2. If that the ink temperature measured by the ink temperature measurement unit 5 is not determined to be within the second temperature range, the determination unit for enabling the ink replenishment disables the ink replenishment operation.

The ink flux per unit time of the ink replenished to the sub-tank 2 from the main tank 10 after exchanging the main tank 10 is constant independently of the remaining ink amount of the sub-tank 2.

It is assumed that the ink temperature in an exchanged main tank 10 is so low that it cannot be adjusted to the setting temperature during the one-time passage through the ink temperature adjustment unit 3. It is also assumed that the remaining ink amount in the sub-tank 2 is constant when the ink replenishment from the main tank 10 starts. In this case, as the ink temperature of the main tank 10 is lower, the ink temperature measured by the ink temperature measurement unit 5 is greatly changed.

The sub-tank 2 to which the ink is replenished from the main tank 10 is arranged far from the ink temperature measurement unit 5. Therefore, there is a time lag between the timing for starting the ink replenishment from the main tank 10 and the timing for detecting a change in ink temperature by the ink temperature measurement unit 5.

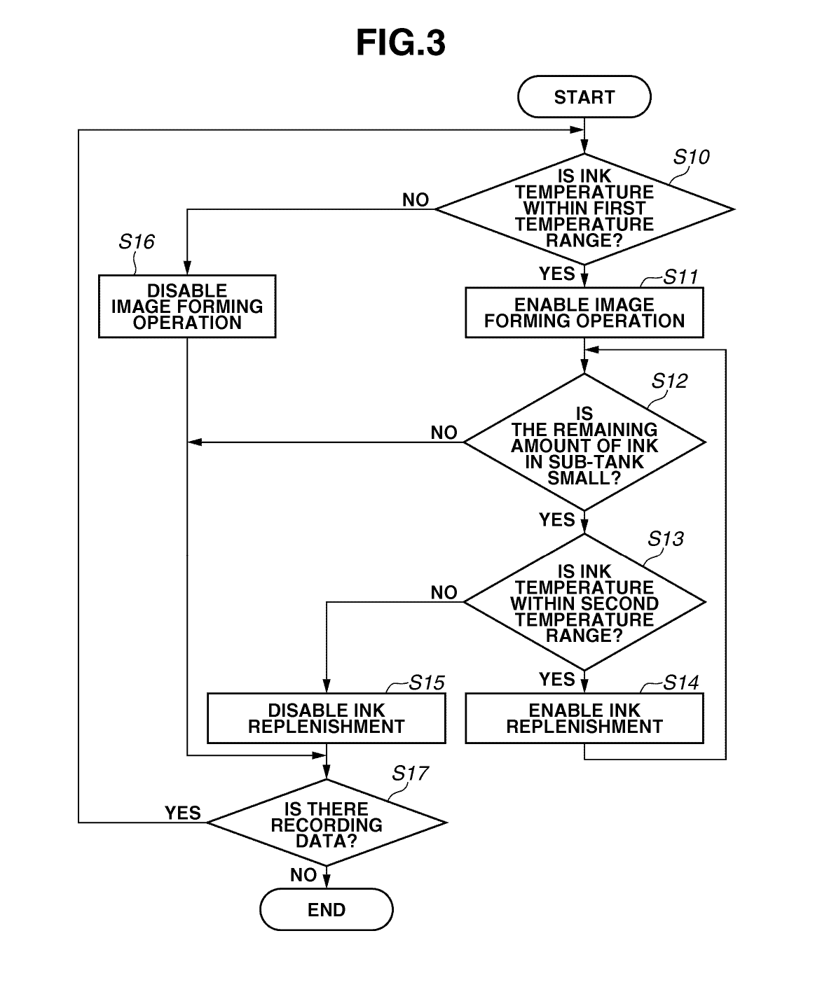

A configuration for the image forming operation, the ink replenishment operation, and the ink temperature control operation, based on the ink temperature measured near the recording head 1, is described with reference to FIG. 3. FIG. 3 is a flowchart illustrating a control sequence according to the first exemplary embodiment.

According to the present exemplary embodiment, by performing the following control method, the image forming operation is continued. As mentioned above, a factor of large change in ink temperature includes the ink replenishment from the main tank 10 to the sub-tank 2. Thus, a stop of the ink replenishment operation is controlled, in addition to the control of the stop of the image forming operation according to the conventional art, under the influence of the temperature of the replenished ink. According to the present exemplary embodiment, it is assumed that the replenished ink temperature is colder than the temperature suitable for image formation.

Referring to FIG. 3, in step S10, it is determined whether the ink temperature in the circulation path is within the first temperature range. If it is determined that the ink temperature is within the first temperature range (YES in step S10), then in step S11, the image forming operation is enabled.

In step S12, the liquid level sensor measures the remaining ink amount in the sub-tank 2. If the remaining ink amount is less than a predetermined amount and the ink replenishment is required from the main tank 10 to the sub-tank 2 (YES in step S12), then in step S13, it is determined whether the ink temperature of the circulation path is within the second temperature range. If the ink temperature is determined to be within the second temperature range (YES in step S13), then in step S14, the ink replenishment from the main tank 10 to the sub-tank 2 is enabled. If the ink temperature is not determined to be within the second temperature range (NO in step S13), then in step S15, the ink replenishment from the main tank 10 to the sub-tank 2 is disabled.

If the ink temperature in the circulation path is not determined to be within the first temperature range (NO instep S10), then in step S16, the determination unit for enabling the image forming operation disables the image forming operation. That is because the image forming quality is not ensured when the ink temperature is not within the first temperature range. In step S17, it is determined whether there is recording data for image formation. If it is determined that there is recording data on which image formation is to be performed (YES in step S17), the processing returns to step S10 again. Although the image forming operation is disabled, the ink circulation operation in the circulation path continues. Thus, by continuing the circulation operation, the ink temperature adjustment unit 3 adjusts the ink temperature to allow the ink temperature to enter the first temperature range. If the ink temperature is determined to be within the first temperature range (YES in step S10), then in step S11, the image forming operation is enabled.

A change in temperature in the circulation system when the ink is replenished is described with reference to FIG. 2. When the ink at a low temperature is replenished from the main tank 10, the temperature of the ink measured by the ink temperature measurement unit 5 is gradually reduced. According to the present exemplary embodiment, in a case where the ink temperature in the circulation path is not determined to be within the second temperature range (timing 21), the ink replenishment operation from the main 10 stops. The ink at the low temperature is not replenished, and the ink circulation operation continues. Accordingly, as illustrated by dashed arrow 22, the ink temperature is gradually heated. The ink temperature is within the first temperature range, therefore, the image forming operation is not interrupted.

Unless the present exemplary embodiment according to the present invention is performed, the ink at the low temperature is continuously replenished from the main tank 10. Accordingly, as illustrated by dashed arrow 23, the temperature of the ink measured by the ink temperature measurement unit 5 is continuously reduced. Then, the ink temperature reaches T1 or less (out of the first temperature range), and the image forming operation is interrupted. Although the image forming operation is interrupted, the ink circulation operation continues. The ink is continuously replenished from the main tank 10 to the sub-tank 2, therefore, it takes a long time to allow the ink temperature to reach a proper temperature.

The present exemplary embodiment describes the example in which the ink at the temperature lower than the temperature suitable for image formation is replenished to the sub-tank 2 from the main tank 10. If the ink at a temperature higher than the temperature suitable for image formation is replenished, a similar advantage is also obtained. The ink may be replenished from the main tank 10 to anywhere in the circulation path except for the sub-tank 2. The setting position of the ink temperature measurement unit 5 is not limited to the present exemplary embodiment, and may be at any position in the circulation path.

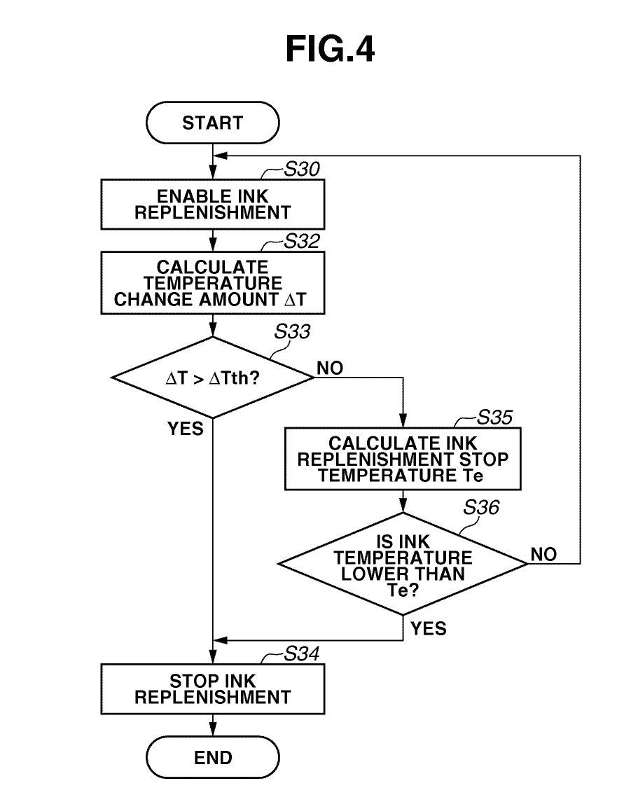

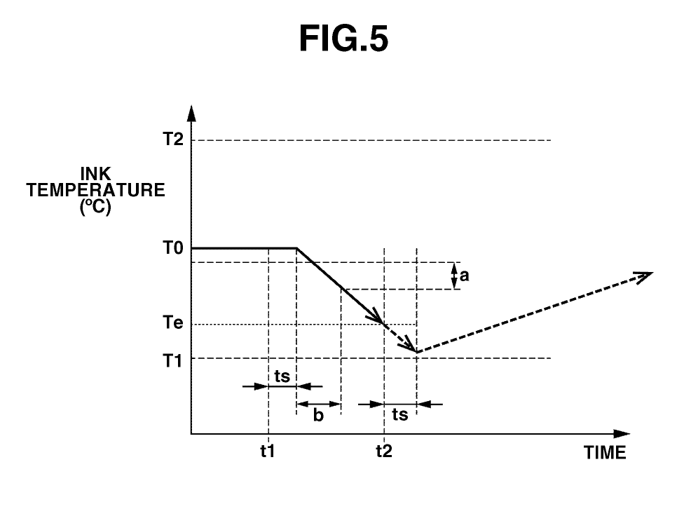

FIG. 4 is a flowchart illustrating a control sequence according to a second exemplary embodiment of the present invention. FIG. 5 is a graph illustrating a change in temperature of the ink when the ink is replenished from the main tank 10 to the sub-tank 2 according to the second exemplary embodiment of the present invention. According to the second exemplary embodiment, the inkjet recording apparatus includes a table of a threshold ΔTth of the temperature change amount and a replenishment stop temperature Te.

The ink replenishment from the main tank 10 to the circulation path is controlled based on the change amount per unit time of the ink temperature measured by the ink temperature measurement unit 5.

An operation is described when the temperature of the ink replenished by the main tank 10 is lower than the temperature suitable for image formation.

A temperature change amount ΔT of the ink per unit time illustrated in FIG. 5 is as follows.

ΔT=a(temperature drop amount)/b(time)

Referring to FIG. 5, after a while from time t1 when the ink replenishment starts from the main tank 10 to the sub-tank 2, the ink temperature of the entire circulation path starts to be changed. A temperature change delay ts is defined to correspond to time from the timing of starting the ink replenishment to starting the temperature change of the ink. In other words, the temperature change delay ts corresponds to time until the temperature change amount of the entire circulation path is stable, and is experimentally obtained.

Referring to FIG. 4, in step S30, the ink replenishment from the main tank 10 to the sub-tank 2 is enabled. Then in step S32, the temperature change amount ΔT measured by the ink temperature measurement unit 5 is calculated. In step S32, it is determined whether the temperature change amount ΔT is larger than a predetermined threshold ΔTth of the temperature change amount. If the temperature change amount ΔT is determined to be larger than the threshold ΔTth (YES in step S33), then in step S34, the ink replenishment from the main tank 10 to the sub-tank 2 stops. In this case, the predetermined threshold ΔTth is calculated as follows.

ΔTth={T0(ink temperature)−T1(lower limit of first temperature range)}/ts(temperature change delay).

If the temperature change amount ΔT is not determined to be larger than the threshold ΔTth (NO in step S33), then in step S35, a temperature Te for stopping the ink replenishment is calculated. The ink replenishment from the main tank 10 stops at the replenishment stop temperature Te, which is calculated based on the temperature change amount ΔT as follows.

Te=ΔT·Ts+T1

If the ink temperature is lower than the replenishment stop temperature Te instep S36, the ink replenishment from the main tank 10 stops at timing (t2) at which the ink temperature reaches the replenishment stop temperature Te. Although the reduction in temperature continues for a predetermined time just after stopping the ink replenishment, it is possible to maintain the ink temperature within the first the temperature range.

If the temperature change amount ΔT is large within the range of the threshold ΔTth, the replenishment stop temperature Te is set to be high. If the temperature change amount ΔT is small, the replenishment stop temperature Te is set to be low. Thus, the amount of ink replenished from the main tank 10 can be large. According to the present exemplary embodiment, the temperature change amount ΔT is measured after time is from the start of ink replenishment. The temperature change amount ΔT decreases gently with time elapse. Therefore, an inclination thereof is not steeper than that at the start time of the ink replenishment. Consequently, as long as the replenishment stop temperature Te is determined once, at least the ink temperature is not out of the first temperature range.

As illustrated in the flowchart in FIG. 4, if the temperature change amount ΔT is larger than the predetermined threshold ΔTth (YES in step S33), then in step S34, the ink replenishment by the replenishment pump 9 immediately stops.

If the temperature change amount ΔT is smaller than the threshold ΔTth (NO in step S33), then in step S35, the ink replenishment stop temperature Te is determined. In step S36, it is determined whether the ink temperature in the circulation path is lower than Te. If the ink temperature in the circulation path is determined to be lower than the ink replenishment stop temperature Te (YES in step S36), then in step S34, the ink replenishment stops. If the ink replenishment stops, the temperature change of the ink in the circulation path does not immediately stop. Therefore, if the temperature change amount ΔT is smaller than the threshold ΔTth, even when the ink replenishment stop temperature Te is set close to the ink temperature T1, the ink is replenished within a range which the ink replenishment stop temperature Te is not lower than T1. If the temperature change amount ΔT is large within a range which the temperature change amount ΔT is not larger than the threshold ΔTth, the ink replenishment stop temperature Te is set to be high so that Te is not larger than the ink temperature T1, thereby increasing the amount of the ink replenished from the main tank 10.

The temperature change amount ΔT may be calculated by measuring a plurality of times. Although the ink replenishment stop temperature Te is calculated according to the present exemplary embodiment, reference may be performed from a table based on the temperature change amount ΔT.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-211119 filed Sep. 27, 2011, which is hereby incorporated by reference herein in its entirety.

What is claimed is:

1. An inkjet recording apparatus comprising:
a recording head configured to discharge ink;
a first ink tank configured to store ink to be supplied to the recording head;
a circulation path configured to circulate ink between the first ink tank and the recording head;
a measurement unit configured to measure an ink temperature in the circulation path;
a second ink tank configured to replenish ink to the circulation path; and
a control unit configured to control replenishment of ink from the second ink tank to the circulation path based on the ink temperature measured by the measurement unit.

2. The inkjet recording apparatus according to claim 1, wherein the control unit disables an image forming operation via the recording head when the ink temperature measured by the measurement unit is not within a predetermined first temperature range.

3. The inkjet recording apparatus according to claim 2, wherein the control unit disables the ink replenishment from the second ink tank to the circulation path when the ink temperature measured by the measurement unit is not within a predetermined second temperature range.

4. The inkjet recording apparatus according to claim 3, wherein the second temperature range is included within the first temperature range.

5. The inkjet recording apparatus according to claim 2, wherein the control unit stops the ink replenishment from the second ink tank to the circulation path when a temperature change amount of the ink per unit time measured by the measurement unit is larger than a threshold.

6. The inkjet recording apparatus according to claim 5, wherein the control unit calculates a replenishment stop temperature for stopping the ink replenishment to the circulation path from the second ink tank when the temperature change amount is not larger than the threshold.

7. The inkjet recording apparatus according to claim 1, wherein ink is replenished from the second ink tank to the first ink tank.

8. The inkjet recording apparatus according to claim 1, further comprising an adjustment unit configured to adjust the ink temperature in the circulation path.

9. The inkjet recording apparatus according to claim 8, wherein the measurement unit is arranged between the adjustment unit and the recording head in the circulation path.

10. The inkjet recording apparatus according to claim 1, wherein the recording head is a line head.
